(19) United States
(12) Patent Application Publication
(10) Pub. No.: US 2001/0030399 A1
(43) Pub. Date: Oct. 18, 2001

(54) Elastic seal for mold tools and method for improving the self-separating properties of such seals

(76) Inventors: Norbert Hoogen, Kleve (DE); Frank Rosen, Viersen (DE); Dieter Lencer, Wegberg (DE)

Correspondence Address: Friedrich Kueffner, Suite1921, 342 Madison Avenue, New York, NY, 10173, US

(21) Appl. No.: 09/800,968

(22) Filed: Mar. 7, 2001

(30) Foreign Application Priority Data
Mar. 9, 2000 (DE) 100 11 550.0

(51) Int. Cl. F16J 3/00

(52) U.S. Cl. 277/628

(57) ABSTRACT

A contour-finished elastic seal of a thermoplastic elastomer for a mold tool is soaked in paraffin oil in order to improve the self-separating properties of the elastic seal before the seal is placed into the mold tool.

### BACKGROUND OF THE INVENTION

1. Field of the Invention

The invention relates to an elastic seal, in particular, an elastic seal for manufacturing interior parts of vehicles of multi-component plastic material, preferably polyurethane, as well as a method for improving the self-separating properties of such seals.

2. Description of the Related Art

Interior parts of vehicles, i.e., door panels or coverings, dashboard panels etc., are parts of a complex configuration in modern vehicle construction and are covered with a decorative foil of fabric or leather. A carrier is provided in the interior. The covering or coating is realized by applying multi-component plastic material, preferably, polyurethane, wherein foaming takes place during the manufacturing process. The multi-component plastic material ensures as a result of its strong tackiness a strong attachment of the decorative foil on the carrier. As a whole, an interior part of vehicles with the desired soft touch properties results.

The mold tools for manufacturing such interior parts of vehicles have a correspondingly complex configuration wherein packing cords are used between the upper and lower tools in order to prevent the multi-component plastic material from leaking out of the mold tool. The packing cords come into contact with the multi-component plastic material during the molding process, and the plastic material and the packing cords adhere to one another as a result of the strong tackiness of the multi-component plastic material. This causes a short and unprofitable service life of the seals. This short service life can be extended only to a limited extent by the massive use of separating agents which are applied to the packing cords.

### SUMMARY OF THE INVENTION

It is an object of the present invention to provide an elastic seal of the aforementioned kind which has the desired elastic properties, can be easily processed, and can be separated particularly easily from the multi-component plastic material which comes into contact with the seal, while the seal exhibits an extended service life. Moreover, it is an object of the invention to provide a corresponding method.

In accordance with the present invention, this is achieved in regard to the elastic seal in that the contour-finished elastic seal is comprised of thermoplastic elastomer (TPE).

The service life, meaning the available period of use of the elastic seal, is significantly increased, i.e., when the multi-component plastic material comes into contact with the seal, it does not adhere strongly to the seal and can be easily removed or separated therefrom. The service life of the seal is increased multiple times in comparison to known seals so that the entire process of producing interior parts of vehicles can be carried out much more economically.

According to a preferred embodiment of the invention, the contour-finished elastic seal of thermoplastic elastomer material (TPE) is produced according to the invention in that it is soaked in paraffin oil before being placed into the mold tool.

### DESCRIPTION OF THE PREFERRED EMBODIMENTS

The elastic seal according to the invention is characterized in that it is contour-finished and comprised of a thermoplastic elastomer (TPE). According to a preferred embodiment, the elastic seal is soaked or immersed in paraffin oil before being placed into the mold tool.

The uptake of paraffin oil can be advantageously temporally controlled by tempering, i.e., the uptake of the paraffin substance by the TPE matrix can be controlled by tempering as well as by the duration of exposure to the paraffin oil.

With the method according to the invention seals are produced that have a service life which is increased by a factor 8 to 10. According to an advantageous embodiment, the thermoplastic elastomer (TPE) is completely free of silicone.

The contour-finished packing cord, i.e., the packing cord in its configuration ready to be mounted in the mold tool, can be soaked before placement into the mold tool in paraffin oil for increasing its service life. Optionally, heat energy is applied during the soaking process. The thermoplastic elastomer material takes up the paraffin oil but maintains its mechanical properties. This additional paraffin oil is taken up and physically bonded in the matrix of the thermoplastic elastomer and does not leak out or drip out. Processes that are carried out subsequently, such as bending, gluing, coating or covering etc., are not impaired.

While specific embodiments of the invention have been shown and described in detail to illustrate the inventive principles, it will be understood that the invention may be embodied otherwise without departing from such principles.

What is claimed is:

1. A contour-finished elastic seal, comprised of a thermoplastic elastomer, for a mold tool.

2. The contour-finished elastic seal according to claim 1, wherein the contour-finished elastic seal is soaked in paraffin oil before being placed into the mold tool.

3. The contour-finished elastic seal according to claim 1, wherein the mold tool serves for manufacturing interior parts of vehicles made of multi-component plastic material.

4. The contour-finished elastic seal according to claim 3, wherein the multi-component plastic material is polyurethane.

5. A method of improving self-separating properties of a contour-finished elastic seal according to claim 1, the method comprising the step of soaking the contour-finished elastic seal in paraffin oil before the elastic seal is placed into the mold tool.

6. The method according to claim 5, further comprising the step of controlling uptake of the paraffin oil by tempering.
